(19) United States
(12) Patent Application Publication
(10) Pub. No.: US 2017/0178190 A1
(43) Pub. Date: Jun. 22, 2017

(54) ADVERTISEMENT DEVICE AND ADVERTISEMENT DISPLAYING METHOD

(71) Applicants: Inventec (Pudong) Technology Corporation, Shanghai (CN); INVENTEC CORPORATION, TAIPEI CITY (TW)

(72) Inventor: Jin-Shan WU, SHANGHAI (CN)

(21) Appl. No.: 15/365,891

(22) Filed: Nov. 30, 2016

(30) Foreign Application Priority Data
Dec. 17, 2015 (CN) 201510954881.5

(51) Int. Cl. G06Q 30/02; H04N 5/232; H04N 7/18; G06F 17/30; G06K 9/00

(52) U.S. Cl. CPC G06Q 30/0261; G06Q 30/0269; G06F 17/30598; G06F 17/30864; G06K 9/00778; G06K 9/00288; G06K 9/00369; H04N 7/183; H04N 5/23293; H04N 7/188; H04L 67/10

(57) ABSTRACT

An advertisement device includes a detecting unit, an image capturing unit, a voice receiving unit, a processing unit, a transmission unit and a displaying unit. The detecting unit detects a moving target in a preset range. The image capturing unit shoots the moving target in a static state to generate a target image. The target image includes a face image and a body image. The voice receiving unit receives an inquiry voice message from the moving target. The processing unit generates user identification data and advertisement classification data. The transmission unit transmits the user identification data and the advertisement classification data to a cloud database. The display unit receives and displays at least one advertisement data from the cloud database.

### RELATED APPLICATIONS

This application claims priority to Chinese Application Serial Number 201510954881.5, filed Dec. 17, 2015, which is herein incorporated by reference.

### BACKGROUND

Technical Field

The present disclosure relates to an advertisement technology. More particularly, the present disclosure relates to an advertisement device and an advertisement displaying method.

Description of Related Art

With the technological and business evolution, various advertisement displaying devices become an essential information source in our daily life. However, current advertisement displaying devices normally follow a fixed sequence to display a plurality of advertisements. In other words, it is relatively difficult for the current advertisement displaying device to attract users. The situation of the current advertisement display device is due to the lack of interaction with the audience.

### SUMMARY

One embodiment of the present disclosure is related to an advertisement device. The advertisement device is connected to a cloud database. The advertisement device includes a detecting unit, an image capturing unit, a voice receiving unit, a processing unit, a transmission unit and a display unit. The detecting unit detects a moving target in a preset range, and determining a motion state of the moving target. The image capturing unit shoots the moving target being in a static state to generate a target image when the detecting unit determines that the moving target in the preset range is in the static state. The target image includes a face image and a body image. The voice receiving unit receives an inquiry voice message from the moving target being in the static state and being in the preset range. The processing unit determines a gender identification of the moving target and an age identification of the moving target according to the face image and the body image to generate user identification data. The processing unit analyzes inquiry information of the inquiry voice message to generate advertisement classification data. The transmission unit transmits the user identification data and the advertisement classification data to the cloud database. The cloud database correspondingly searches at least one advertisement data according to the user identification data and the advertisement classification data. The display unit receives and displays the at least one advertisement data.

Another embodiment of the present disclosure is related to an advertisement displaying method. The advertisement displaying method is using for an advertisement device. The advertisement displaying method includes: detecting a moving target in a preset range; determining a motion state of the moving target; shooting the moving target being in a static state to generate a target image when the moving target in the preset range is in a static state, wherein the target image includes a face image and a body image; determining a gender identification of the moving target and an age identification of the moving target according to the face image and the body image to generate user identification data; receiving an inquiry voice message from the moving target being in the static state and being in the preset range; analyzing inquiry information of the inquiry voice message to generate advertisement classification data; transmitting the user identification data and the advertisement classification data to the cloud database, wherein the cloud database correspondingly searches at least one advertisement data according to the user identification data and the advertisement classification data; and receiving and displaying the at least one advertisement data.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an advertisement device and a cloud database according to one embodiment of the present disclosure;

FIG. 2 is a schematic diagram illustrating a plurality of advertisement devices and a cloud database according to one embodiment of the present disclosure; and

FIG. 3 is a flow diagram illustrating an advertisement displaying method with an identity recognition function according to one embodiment of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

Moreover, the drawings are for the purpose of illustration only, and are not in accordance with the size of the original drawing. The components in description are described with the same number to understand.

Unless otherwise defined, all terms used in this specification and claims generally have their ordinary meaning in the art, within the context of the disclosure, and in the specific context where each term is used. Certain terms that are used to describe the disclosure are discussed below, or elsewhere in the specification, to provide additional guidance to the practitioner regarding the description of the disclosure.

The terms “comprises”, “comprising”, “includes”, “including”, “has”, “having” . . . etc used in this specification are open-ended and their meaning are “comprises but not limited”.

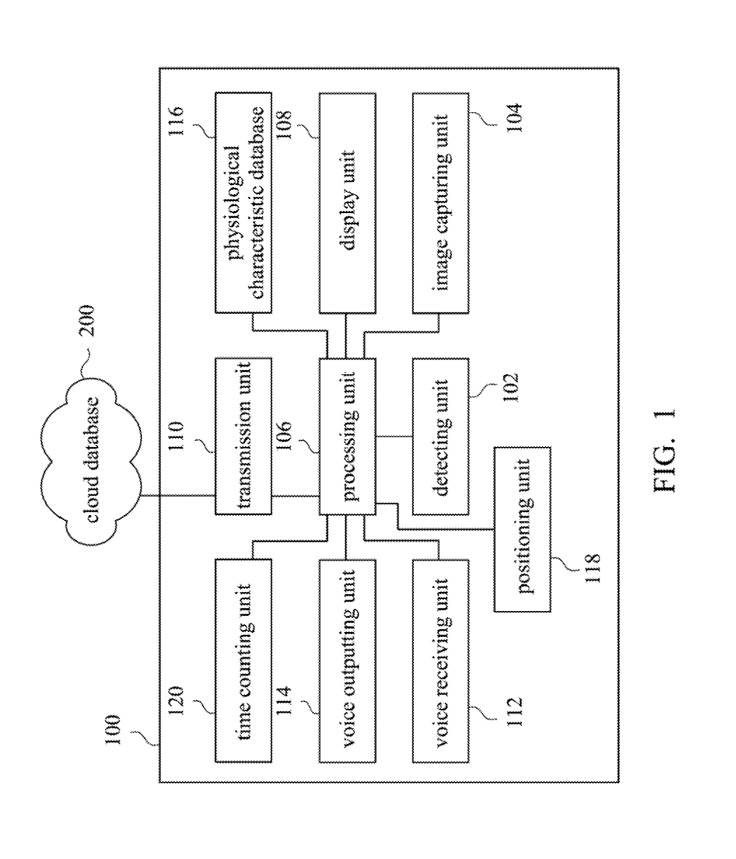

FIG. 1 is a schematic diagram illustrating an advertisement device 100 and a cloud database 200 according to one embodiment of the present disclosure. As illustratively shown in FIG. 1, the advertisement device 100 is connected to the cloud database 200. In some embodiments, the advertisement device 100 logs in a user account to be connected to the cloud database 200. In other words, the advertisement device 100 is connected to the cloud database 200 through the Internet. The cloud database 200 stores much advertisement data. The advertisement data may be from an advertiser, or from a plurality of advertisers. The advertisement device 100 receives the advertisement data from the cloud database 200 and displays the advertisement data.

As illustrated in FIG. 1, in some embodiments, the advertisement device 100 includes a detecting unit 102, an image capturing unit 104, a processing unit 106, a display unit 108, a transmission unit 110 and a voice receiving unit 112. The processing unit 106 is coupled to the detecting unit 102, the image capturing unit 104, the display unit 108, the transmission unit 110, and the voice receiving unit 112.

As used herein, “coupled” may refer to two or more elements are in direct physical or electrical contact made, or indirectly, as a mutual entity or electrical contact, and coupled may also refer to two or more elements are operating or action.

The detecting unit 102 detects a moving target (for example, a person) is in a preset range, and determines a motion state of the moving target. The detecting unit 102 may be an infrared ray detector, a thermal detector or other detectors with a detecting function. In some embodiments, the preset range is a circle shape area. The advertisement device 100 is disposed at a center of the circle shape area. A radius of the circle shape area is a predetermined distance. In some other embodiments, the preset range is a rectangular shape area, a fan shape area, a trapezium shape area or other geometrical shape areas. A distance between the advertisement device 100 and the preset range is a predetermined distance. The predetermined distance may be 0-10 meters. In some embodiments, the predetermined distance being 0-5 meters is better. When the moving target is in the preset range, the detecting unit 102 detects the moving target and determines the motion state of the moving target. For example, the detecting unit 102 may determine that the moving target is in a static state or in a moving state.

The image capturing unit 104 shoots an image. The image capturing unit 104 may be a charge couple device (CCD), a complementary metal-oxide semiconductor (CMOS), or other hard elements with an image capturing function. When the detecting unit 102 detects the moving target in the preset range and determines that the moving target is in the static state, the image capturing unit 104 shoots the moving target to generate a target image. In some embodiments, the target image includes a face image and a body image.

The processing unit 106 performs various analyzing and calculating. The processing unit 106 determines a gender identification of the moving target and an age identification of the moving target according to the above-mentioned face image and the above-mentioned body image, to generate user identification data. In some embodiments, the body image includes at least one gender characteristic of the moving target, and the face image includes at least one face age characteristic of the moving target. The processing unit 106 may compare the gender characteristic and the face age characteristic with a physiological characteristic database 116 or according to various people characteristic identification algorithm, to determine the gender of the moving target (gender identification) or the age of the moving target (age identification), so as to generate the user identification data. In other words, in some embodiments, the user identification data includes the gender identification and the age identification. For example, the processing unit 106 determines the gender of the moving target according to the wearing of the moving target or a length of the hair of the moving target. Moreover, the face image includes at least one face gender characteristic. The processing unit 106 determines the gender of the moving target according to the face gender characteristic. Moreover, the processing unit 106 may also determine an age range of the moving target according to the face age characteristic of the moving target. The age range is, for example, a child range, an adult range, or an older adult range. The processing unit 106 may be a CPU, a micro control element, a microprocessor, a DSP, an application specific integrated circuitry (ASIC) or a logic circuit. In some embodiments, the above-mentioned people characteristic identification algorithm is implemented with a computer program and is stored in a storage medium. The processing unit 106 executes the computer program in the storage medium to perform functions of people characteristic identification.

The voice receiving unit 112 receives an inquiry voice message from the moving target being in the static state and being in the preset range. The voice receiving unit 112 may be a microphone or other devices with a voice receiving function. In some embodiments, the inquiry voice message includes inquiry information. In other words, the inquiry voice message is a voice message from the moving target and for providing a question. When the voice receiving unit 112 receives the inquiry voice message from the moving target, the processing unit 106 may analyze the inquiry information of the inquiry voice message by using a voice identification technology or other voice technology, to generate advertisement classification data. For example, if the inquiry information of the inquiry voice message is associated with food stores, the processing unit 106 may generate the advertisement classification data corresponding to food stores.

Then, the transmission unit 110 transmits the user identification data and the advertisement classification data to the cloud database 200. The cloud database 200 searches at least one advertisement data according to the user identification data and the advertisement classification data. For example, if identification data of the user indicates that the moving target is an adult female and the advertisement classification data is corresponding to a shopping classification, the cloud database 200 searches a plurality of advertisement data corresponding to adult females and the shopping classification. Then, the advertisement device 100 receives the advertisement data from the cloud database 200, such that the display unit 108 of the advertisement device 100 displays these advertisement data. The advertisement data are, for example, cosmetic advertisements, female dresses advertisements, or female shoes advertisements, but are not limited thereof. Moreover, if identification data of the user indicates that the moving target is a little boy and the advertisement classification data is corresponding to a toy classification, the cloud database 200 searches a plurality of advertisement data corresponding to little boys and the toy classification. Then, the advertisement device 100 receives the advertisement data from the cloud database 200, such that the display unit 108 of the advertisement device 100 displays the advertisement data, such as toy car advertisements, toy model advertisements, or toy exhibition advertisements, but are not limited thereof. Since the advertisements displayed on the advertisement device 100 is for the moving target, an effect of attracting the moving target to stop to see the advertisements is achieved. The display unit 108 displays a static image or a dynamic image. The display unit 108 may be a display panel, a touch display panel or other devices with a displaying function.

The above illustrations include exemplary operations in sequence, but the operations are not necessarily performed in the order shown. Various orders of the operations are within the contemplated scope of the present disclosure. Moreover, operations may be added, replaced, changed order, and/or eliminated as appropriate, in accordance with the spirit and scope of various embodiments of the present disclosure.

In some embodiments, the processing unit 106 determines whether there is a pet near the moving target or not by using a pet identification method even to figure out a classification of the pet. The advertisement device 100 may receive corresponding advertisement data from the cloud database 200. For example, if the processing unit 106 determines that the pet near the moving target is a dog, the advertisement device 100 may receive advertisement data corresponding to dog food or doghouses from the cloud database 200. Since the pet of the moving target is the dog, it is possible that the moving target is attracted by the advertisements about dogs, such that an advertising effect of the advertisement device 100 can be promoted.

Moreover, in some embodiments, the detecting unit 102 detects standing time of the moving target being in the static state. The processing unit 106 determines whether the standing time of the moving target is over predetermined concerning time or not. When the standing time of the moving target is over the predetermined concerning time, a possibility that the moving target sees the advertisement content on the advertisement device 100 is higher. Therefore, when the standing time of the moving target is over a predetermined concerning time, the image capturing unit 104 shoots the moving target, such that the advertisement device 100 displays the advertisements corresponding to the moving target. Consequently, a better advertising effect is achieved if the advertisement device 100 displays the advertisements for the moving target whose standing time is longer. In some embodiments, the predetermined concerning time is adjusted according to the demand of each advertiser. The predetermined concerning time may be, for example, 2-5 seconds, but is not limited thereof.

Moreover, in some embodiments, the advertisement device 100 further includes a time counting unit 120. The time counting unit 120 is coupled to the processing unit 106. The time counting unit 120 counts continuous time when the detecting unit 102 does not detect the moving target in the preset range, to generate counting time. When the counting time reaches detecting time, the processing unit 106 generates a stop instruction, such that the display unit 108 stops displaying the advertisement data. However, if the counting time is smaller than the detecting time, the displaying unit 108 displays the advertisements in a fixed sequence. The above-mentioned detecting time is a time threshold value of allowing the advertisement device 100 to display the advertisements in the fixed sequence when the detecting unit 102 does not detect the moving target in the preset range.

Moreover, in some embodiments, when the detecting unit 102 determines that the moving target in the preset range is in a moving state, the image capturing unit 104 shoots the scene of the preset range in setting time to generate an area image. The area image includes at least one people image. The processing unit 106 computes a gender ratio value according to gender and number of people in the area image. For example, the area image shot by the image capturing unit 104 may include many people. In one embodiment, the processing unit 106 determines a common characteristic (such as, gender) of the people and receives advertisement data corresponding to the common characteristic from the cloud database 200 according to the common characteristic. For example, if the processing unit 106 determines that a number of males in the area image is larger than a number of females in the area image, the advertisement device 100 receives the advertisements corresponding to males from the cloud database 200 to display the advertisements corresponding to men. The advertisement data corresponding to males are, for example, leather shoe advertisements, suit advertisements or car advertisements. For example, if the processing unit 106 determines that a number of children in the area image is larger than a number of adults in the area image, the advertisement device 100 receives the advertisements corresponding to children from the cloud database 200 to display the advertisements corresponding to children. These advertisement data corresponding to children are, for example, toy advertisements, candy advertisements or amusement park advertisements. Thus, the advertisement device 100 displays the advertisements according to the common characteristic of the people in the area image, such that the advertising effect of the advertisement device 100 can be promoted.

In some other embodiments, after the processing unit 106 determines gender and number of people in the area image according to the people image to compute a gender ratio value, the cloud database 200 searches advertisements corresponding to males or corresponding to females according to the gender ratio value. For example, if the gender ratio value indicates that the number of males in the image is larger than the number of females in the image, the cloud database 200 searches more advertisements corresponding to males and less advertisements corresponding to females. Then, the advertisement device 100 generates a displaying time ratio according to the gender ratio value, and displays the advertisements according to the displaying time ratio. For example, if the gender ratio value of males to females in the image is 7:3, the advertisement device 100 displays the advertisements corresponding to males in seven minutes of every ten minutes, and displays the advertisements corresponding to females in remain three minutes of every ten minutes. Since the number of males in the image is larger, the advertising effect of the advertisement device 100 can be promoted if the advertisement device 100 spends more time displaying the advertisements corresponding to men.

In some embodiments, the advertisement device 100 further includes a voice outputting unit 114. The voice outputting unit 114 is coupled to the processing unit 106. The voice outputting unit 114 outputs a greeting voice message or an advertisement voice message corresponding to the advertisement data. The voice outputting unit 114 may be a loudspeaker, an earphone or other devices with a voice outputting function. In some embodiments, the voice outputting unit 114 may output the greeting voice message to attract the moving target to stand in front of the advertisement device 100, to promote the advertising effect of the advertisement device 100. The greeting voice message is, for example, “good morning,” “hello” or etc. Moreover, in some embodiments, the voice outputting unit 114 may outputs the advertisement voice message corresponding to the advertisement data. In other words, if the advertisement data includes an image part and a voice part, the image part is displayed on the displaying unit 108, and the voice part is outputted from the voice outputting unit 114.

Moreover, in some embodiments, the advertisement device 100 further includes a positioning unit 118. The positioning unit 118 is coupled to the processing unit 106. The positioning unit 118 may be a global positioning system (GPS). When the voice outputting unit 114 plays the greeting voice message, the positioning unit 118 determines a coordination position of the moving target being in a static state. When the coordination position is in a predetermined coordination range position, the voice receiving unit 112 receives the inquiry voice message from the moving target, such that the processing unit 106 analyzes the inquiry voice message and generates the advertisement classification data according to the inquiry information of the inquiry voice message. The predetermined coordination range is a range of coordination of the above-mentioned preset range. Therefore, the inquiry voice message of a moving target who is far away from the advertisement device 100 is prevented from being receiving by the voice receiving unit 114, to promote the advertising effect of the advertisement device 100.

In some embodiments, the positioning unit 118 sends out position information of the advertisement device 100. The transmission unit 110 transmits the user identification data, the advertisement classification data, and the position information to the cloud database 200. For example, if the advertisement classification data is corresponding to a toy classification and the user identification data indicates that the moving target is a lithe boy, the cloud database 200 searches the advertisement data of stores selling little boy' toys. The positions of the stores are adjacent to the advertisement device 100. The cloud database 200 transmits the advertisement data to the advertisement device 100, such that the display unit 108 of the advertisement device 100 displays the advertisement data. Since the distances between the stores and the advertisement device 100 is not too large, the possibility that the moving target goes to the store is very high, such that the advertising effect of the advertisement device 100 is promoted.

In some embodiments, when the voice receiving unit 112 receives the inquiry voice message from the moving target, the processing unit 106 may control the voice outputting unit 114 to response the inquiry voice message for increasing the interaction between the advertisement device 100 and the moving target.

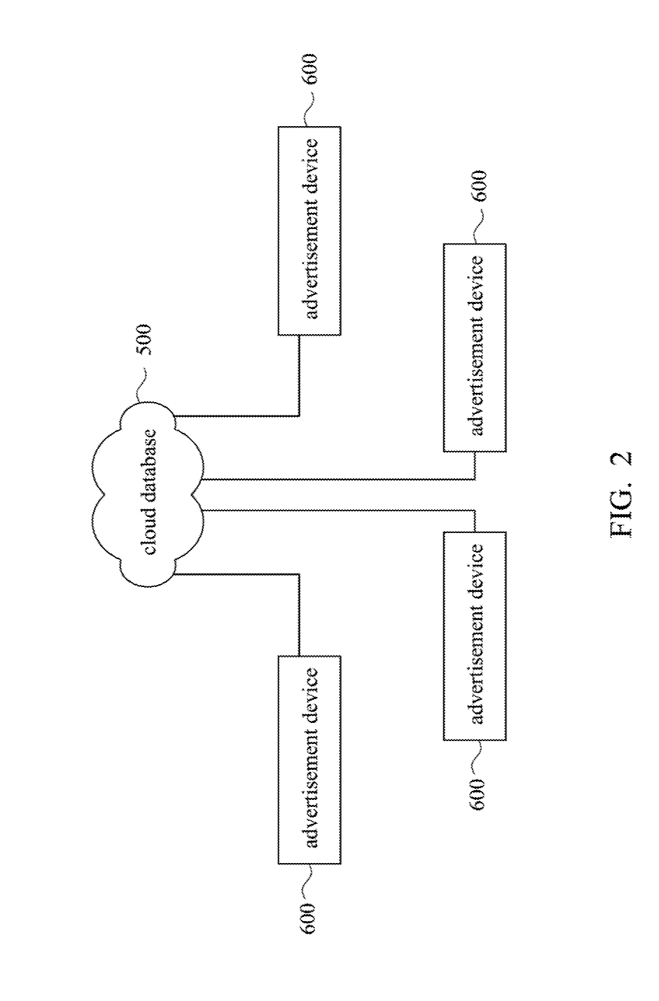

FIG. 2 is a schematic diagram illustrating a plurality of advertisement devices 600 and a cloud database 500 according to one embodiment of the present disclosure. The cloud database 500 is similar to the cloud database 200 in FIG. 1 except the reference numerals increased by 300. Moreover, each of advertisement devices 600 is similar to the cloud database 100 in FIG. 1 except the reference numerals increased by 500. Each of advertisement devices 600 is connected to the cloud database 500. In some embodiments, the advertisement devices 600 log in a user account to be connected to the cloud database 500. In some embodiments, the advertisement devices 600 log in different user accounts respectively to be connected to the cloud database 500.

In some embodiments, each advertisement devices 600 can be disposed at different positions to display advertisements for different users. For example, the advertisement devices 600 may be disposed at different floors in a department store respectively. Since the commodities for different consumers may be sold at different floors in a department store, major consumer groups of each floor may be different. For example, if dresses for females are sold at a first floor, the major consumer group of the first floor may be females. Therefore, a possibility that the advertisement device 600 disposed at the first floor determines that the chances of the moving target being a female is larger. Thus, the advertisement device 600 disposed at the first floor displays the advertisements corresponding to females. If men's clothing is sold at a second floor, the major consumer group of the second floor may be men. Therefore, a possibility that the advertisement device 600 disposed at the second floor determines that the chances of the moving target being a male is larger. Thus, the advertisement device 600 disposed at the second floor displays the advertisements corresponding to men. In other words, each advertisement device 600 displays different advertisements corresponding to different consumer groups, to effectively promote the advertising effects of each advertisement device 600.

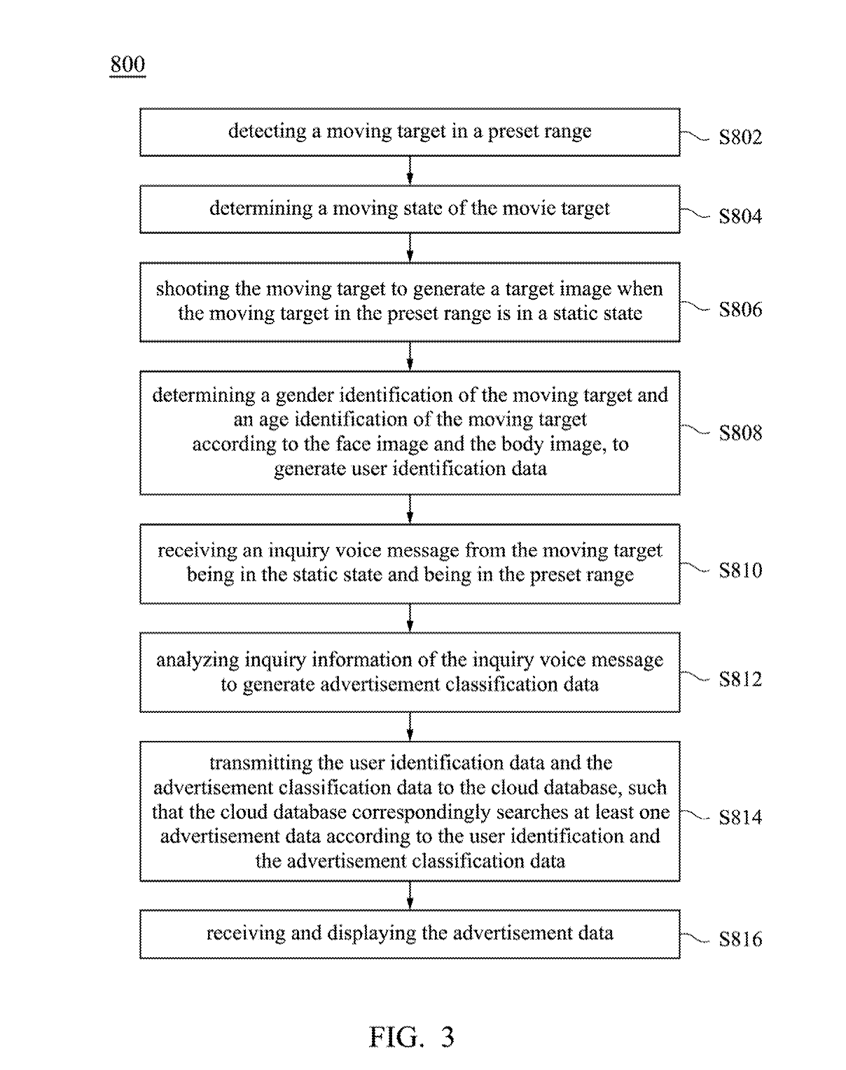

FIG. 3 is a flow diagram illustrating an advertisement displaying method 800 with an identity recognition function according to one embodiment of this disclosure. In some embodiments, the advertisement displaying method 800 in FIG. 3 may be implemented in the advertisement device 100 in FIG. 1. As illustratively shown in FIG. 3, the advertisement displaying method 800 with the identity recognition function includes steps S802-S814.

In step S802, the detecting unit 102 detects a moving target in a preset range.

In step S804, the detecting unit 102 determines a motion state of the moving target. The motion state of the moving target may be a static state or a moving state.

In step S806, when the detecting unit 102 determines that the moving target in the preset range is in a static state, the image capturing unit 104 shoots a scene of the moving target being in a static state to generate a target image. In some embodiments, the target image includes a face image and a body image.

In step S808, the processing unit 106 determines a gender identification of the moving target and an age identification of the moving target according to the face image and the body image to generate user identification data.

In step S810, the voice receiving unit 112 receives an inquiry voice message from the moving target being in the static state and being in the preset range.

In step S812, the processing unit 106 analyzes inquiry information of the inquiry voice message to generate advertisement classification data.

In step S814, the transmission unit 110 transmits the user identification data and the advertisement classification data to the cloud database 200. The cloud database 200 correspondingly searches at least one advertisement data according to the user identification data and the advertisement classification data.

In step S816, the displaying unit 108 receives and displays the advertisement data.

As the above embodiments, the advertisement device and the advertising displaying method with the identity recognition function attract users to see advertisements by displaying advertisements corresponding to users, so as to promote an advertising effect. Moreover, in some embodiments, advertisement devices and advertising displaying methods with the identity recognition function attract users to see advertisements by interacting with users, so as to promote advertising effect.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An advertisement device, connected to a cloud database, wherein the advertisement device comprises:
a detecting unit, detecting a moving target in a preset range, and determining a motion state of the moving target;
an image capturing unit, shooting the moving target being in a static state to generate a target image when the detecting unit determines the moving target in the preset range is in the static state, wherein the target image comprises a face image and a body image;
a voice receiving unit, receiving an inquiry voice message from the moving target being in the static state and being in the preset range;
a processing unit, determining a gender identification of the moving target and an age identification of the moving target according to the face image and the body image to generate user identification data, and analyzing inquiry information of the inquiry voice message to generate advertisement classification data;
a transmission unit, transmitting the user identification data and the advertisement classification data to the cloud database, wherein the cloud database correspondingly searches at least one advertisement data according to the user identification data and the advertisement classification data; and
a display unit, receiving and displaying the at least one advertisement data.

2. The advertisement device of claim 1, wherein the body image comprises at least one gender characteristic of the moving target, the face image comprises at least one face age characteristic of the moving target, and the processing unit compares the at least one gender characteristic and the at least one face age characteristic with a physiological characteristic database to determine the gender identification of the moving target and the age identification of the moving target.

3. The advertisement device of claim 1, wherein when the detecting unit determines that the moving target in the preset range is in a moving state, the image capturing unit shoots the scene of the preset range in a setting time to generate an area image, the area image comprises at least one people image;
the processing unit determines gender and number of people in the area image according to the at least one people image to compute a gender ratio value;
the transmission unit transmits the gender ratio value to the cloud database, and receives a plurality of male advertisement data and a plurality of corresponding female advertisement data searched by the cloud database according to the gender ratio value, the processing unit determines a displaying time ratio of the male advertisement data and the female advertisement data according to the gender ratio value, and the display unit displays the male advertisement data and the female advertisement data according to the displaying time ratio.

4. The advertisement device of claim 1, further comprising:
a voice outputting unit, playing a greeting voice message; and
a positioning unit, determining a coordination position of the moving target being in a static state, wherein when the coordination position is in a preset range position, the voice receiving unit receives the inquiry voice message from the moving target, and the processing unit analyzes the inquiry voice message and determines an advertisement classification according to the inquiry information of the inquiry voice message for generating the advertisement classification data.

5. The advertisement device of claim 1, further comprising:
a time counting unit, counting a continuous time when the detecting unit does not detect the moving target in the preset range to generate a counting time, wherein when the counting time reaches a detecting time, the processing unit generates a stop instruction, such that the displaying unit stops displaying the advertisement data.

6. An advertisement displaying method with an identity recognition function, wherein the advertisement displaying method is using for an advertisement device, and the advertisement displaying method comprises:
detecting a moving target in a preset range;
determining a motion state of the moving target;
shooting the moving target being in a static state to generate a target image when the moving target in the preset range is in a static state, wherein the target image comprises a face image and a body image;
determining a gender identification of the moving target and an age identification of the moving target according to the face image and the body image to generate user identification data;
receiving an inquiry voice message from the moving target being in the static state and being in the preset range;
analyzing inquiry information of the inquiry voice message to generate advertisement classification data;
transmitting the user identification data and the advertisement classification data to the cloud database, wherein the cloud database correspondingly searches at least one advertisement data according to the user identification data and the advertisement classification data; and
receiving and displaying the at least one advertisement data.

7. The advertisement displaying method of claim 6, wherein the body image comprises at least one gender characteristic of the moving target, and the face image comprises at least one face age characteristic of the moving target, wherein the step of determining the gender identification of the moving target and the age identification of the moving target according to the face image and the body image comprises:
comparing the at least one gender characteristic and the at least one face age characteristic with a physiological characteristic database to determine the gender identification of the moving target and the age identification of the moving target.

8. The advertisement displaying method of claim 6, further comprising:
shooting the scene of the preset range in a setting time to generate an area image when the moving target in the preset range is in a moving state, wherein the area image comprises at least one people image;
determining gender and number of people in the area image according to the at least one people image to compute a gender ratio value;
transmitting the gender ratio value to the cloud database and receiving a plurality of male advertisement data and a plurality of corresponding female advertisement data searched by the cloud database according to the gender ratio value; and
determining a displaying time ratio of the male advertisement data and the female advertisement data according to the gender ratio value, and displaying the male advertisement data and the female advertisement data according to the displaying time ratio.

9. The advertisement displaying method of claim 6, wherein the step of generating the advertisement classification data comprises:
playing a greeting voice message;
determining a coordination position of the moving target being in a static state; and
receiving the inquiry voice message from the moving target when the coordination position is in the preset range; and analyzing the inquiry voice message and determining an advertisement classification according to the inquiry information of the inquiry voice message for generating the advertisement classification data.

10. The advertisement displaying method of claim 6, further comprising:
counting a continuous time when the moving target is not detected in the preset range to generate a counting time; and
stopping displaying the advertisement data hen the counting time reaches a detecting time.
